(19) United States
(12) Patent Application Publication
(10) Pub. No.: US 2020/0212507 A1
(43) Pub. Date: Jul. 2, 2020

(54) ELECTRICITY STORAGE SYSTEM AND MANAGEMENT DEVICE

(71) Applicant: Panasonic Intellectual Property Management Co., Ltd., Osaka (JP)

(72) Inventors: KEISUKE SHIMIZU, Osaka (JP); TAKESHI NAGAO, Osaka (JP)

(21) Appl. No.: 16/639,087

(22) PCT Filed: Jul. 11, 2018
(86) PCT No.: PCT/JP2018/026116

§ 371 Date: Feb. 13, 2020

(30) Foreign Application Priority Data
Aug. 25, 2017 (JP) 2017-162628

(51) Int. Cl. H01M 10/42; H01M 2/10; H01M 10/48; H01M 10/04; H01M 10/613; H01M 10/647

(52) U.S. Cl. CPC H01M 10/425; H01M 2/1077; H01M 10/4207; H01M 2010/4271; H01M 10/0413; H01M 10/613; H01M 10/647; H01M 10/482

(57) ABSTRACT

In an electricity storage system where each of electricity storage modules includes cells that are bound in a state where the cells are stacked in a row. A management device acquires detection values from sensors that are respectively mounted on the electricity storage modules so as to detect expansion or contraction of the cells in a stacking direction. The management device is configured to compare a detection value acquired from the sensor mounted on one electricity storage module to be inspected and detection values acquired from the sensors mounted on other electricity storage modules, and to detect an abnormality in one of the cells included in the one electricity storage module to be inspected.

### TECHNICAL FIELD

The present invention relates to an electricity storage system including a plurality of electricity storage modules, and a management device for controlling the plurality of electricity storage modules.

### BACKGROUND ART

Along with hybrid vehicles and electric vehicles becoming widespread, shipping of vehicle-mounted batteries has been increased in recent years. Further, shipping of stationary electricity storage systems which can be used as peak shift power sources or as backup power sources has been increased. In a vehicle-mounted battery pack and an electricity storage battery pack, several tens to several thousands of cells are connected in series or parallel to each other thus forming a high-voltage and large-capacity battery. In the case where an abnormality occurs in the cell of the battery pack, it is necessary to rapidly detect the abnormality and to stop the use of the battery pack or to apply a predetermined safety measure to the battery pack.

As one method of detecting abnormality in the cell, there has been known a method of measuring a temperature of the cell. However, to detect the abnormality in the cell with certainty, it is necessary to measure temperatures of all cells in the battery pack using temperature sensors (for example, thermistors). In this case, it is necessary to install a large number of temperature sensors and hence, a cost and a number of parts are increased.

Further, with respect to a battery pack using an electricity storage module including a plurality of cells, there has been known a method where a strain of a module member brought about by an expansion of the cell attributed to an abnormality in the cell is measured by a pressure sensor, and it is determined that the abnormality occurs when a measured value exceeds a threshold. In this method, it is possible to detect an abnormality by merely providing one pressure sensor to the electricity storage module.

### CITATION LIST

### Patent Literature

PTL 1: Unexamined Japanese Patent Publication No. 2006-24445

### SUMMARY OF THE INVENTION

### Technical Problem

However, to set a threshold of a strain amount at which it is determined that an abnormality occurs, an enormous amount of ex-ante evaluations becomes necessary by taking into account various in-use states. Further, in the case where a strain amount of a battery at a normal use time and a strain amount of a battery when an abnormality occurs are close to each other, there is a possibility that an erroneous detection occurs. Also in the case where an unexpected use method is adopted, there is a possibility that an erroneous detection occurs.

The present invention has been made in view of such circumstances, and it is an object of the present invention to provide a technique for detecting an abnormality in a cell with simple configuration and with high accuracy.

### Solutions to Problems

To achieve the above-mentioned drawbacks, an electricity storage system according to an aspect of the present invention includes: a plurality of electricity storage modules each including a plurality of cells that are bound in a state where the cells are stacked in a row; and a management device that acquires detection values of sensors that are respectively mounted on the plurality of electricity storage modules and detect expansion or contraction of the plurality of cells in a stacking direction. The management device is configured to compare a detection value acquired from the sensor mounted on one electricity storage module to be inspected out of the plurality of electricity storage modules and detection values acquired from the sensors mounted on other electricity storage modules, and to detect an abnormality in at least one of the cells included in the one electricity storage module to be inspected.

Any desired combinations of the above-described configuration elements and converted expressions of the present invention in methods, devices, systems, and other similar entities are still effective as aspects of the present invention.

### Advantageous Effect of Invention

According to the present invention, it is possible to detect an abnormality in the cell with the simple configuration and with high accuracy.

### BRIEF DESCRIPTION OF DRAWINGS

FIG. 1 is a schematic view of a system configuration of an electricity storage system according to an exemplary embodiment of the present invention.

FIG. 2 is a view showing one example of detection values of a first strain gauge to an eighth strain gauge in the case where an abnormality occurs in the cell included in a fifth electricity storage module.

FIG. 3 is a flowchart showing a flow of a method of detecting an electricity storage module including an abnormal cell using a management device according to an exemplary embodiment of the present invention.

FIG. 4 is a schematic view showing a system configuration of an electricity storage system which is operated in cooperation with a cooling unit.

FIG. 5(a) and FIG. 5(b) are views showing a reconfiguration example of the first electricity storage module to the eighth electricity storage module at the time of detecting an electricity storage module including an abnormal cell.

FIG. 6 is a view showing another reconfiguration example of the first electricity storage module to the eighth electricity storage module at the time of detecting an electricity storage module including an abnormal cell.

### DESCRIPTION OF EMBODIMENT

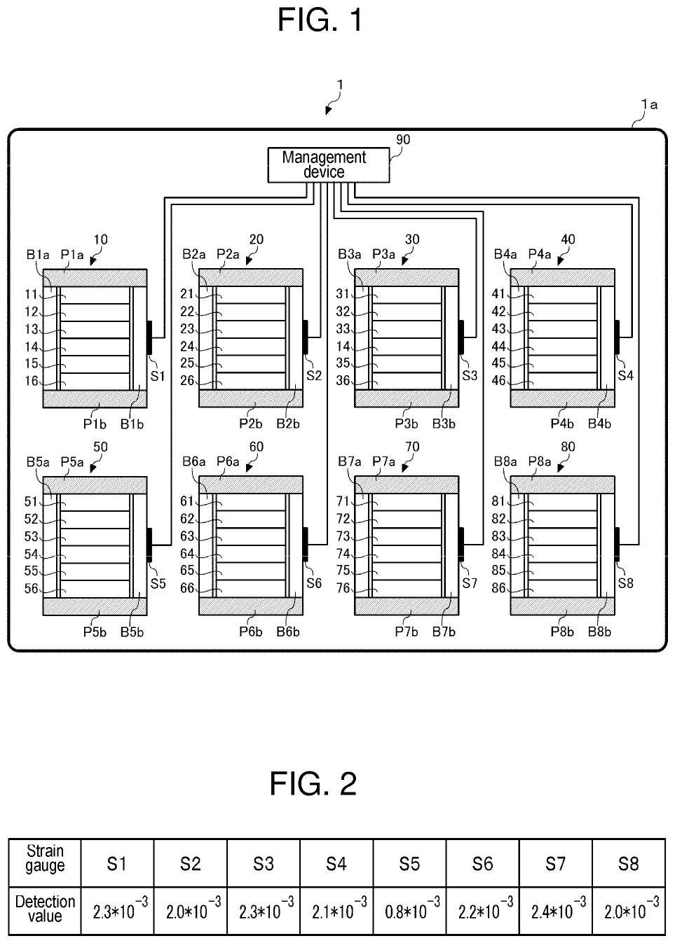

FIG. 1 is a schematic view of a system configuration of electricity storage system 1 according to an exemplary embodiment of the present invention. Electricity storage system 1 includes a plurality of electricity storage modules 10 to 80 and management device 90 in outer case 1a. Hereinafter, in this exemplary embodiment, the description is made by taking the case where eight electricity storage modules (first electricity storage module 10 to eighth electricity storage module 80) are housed as an example.

First electricity storage module 10 includes a plurality of cells 11 to 16. Although FIG. 1 shows an example where each electricity storage module houses six cells, a number of cells housed in each electricity storage module may be more than 6 or may be less than 6. Further, the plurality of cells 11 to 16 may be electrically connected to each other in any one of connection modes among a series connection, a parallel connection, and a series-parallel connection. In the description made hereinafter, the case is estimated that the plurality of cells 11 to 16 are electrically connected with each other in the series connection.

The cell is a rectangular-shaped unit cell, and a lithium ion battery, a nickel hydride battery, a lead-acid battery or the like can be used as the cell. Hereinafter, in this specification, an example where a lithium ion battery is used as the cell is estimated. The plurality of cells 11 to 16 are stacked on each other in a row using the surfaces having a largest area of each cell as stacking surfaces. Two end plates P1a, P1b are disposed on both end surfaces of an assembly of the plurality of cells 11 to 16 in a stacking direction so as to sandwich the plurality of cells 11 to 16. End plates P1a, P1b disposed on both ends are connected to each other using a plurality of side bind bars. Specifically, at least one side bind bar B1a, B1b is disposed on both sides of the assembly of the plurality of stacked cells 11 to 16. First strain gauge S1 is attached to one of the plurality of side bind bars B1a, B1b. In FIG. 1, first strain gauge S1 is attached to right side bind bar B1.

First strain gauge S1 includes a metal resistor whose resistance value changes in proportion to the expansion or contraction of side bind bar B1b which is an object to be measured. The metal resistor is attached to side bind bar B1b in an insulated manner. Accordingly, the metal resistor is also applicable to side bind bar B1b made of metal. A voltage dividing circuit including the metal resistor and a fixed resistance is connected with management device 90 by wiring, and a change in resistance value of the metal resistor is read by management device 90 as a change in voltage value. For example, Wheatstone bridge circuit can be used as the voltage dividing circuit.

Basically, second electricity storage module 20 to eighth electricity storage module 80 have substantially the same configuration as first electricity storage module 10. First electricity storage module 10 to eighth electricity storage module 80 may be electrically connected to each other in any one of connection modes among a series connection, a parallel connection, and a series-parallel connection. In FIG. 1, for simplifying the figure, connecting members such as bus bars or the like for electrically connecting first electricity storage module 10 to eighth electricity storage module 80 to each other are omitted.

An active material in the lithium ion battery expands by charging the battery, and contracts by discharging the battery. In the above-mentioned example, cell expands or contracts in the above-mentioned stacking direction. Such an expansion or contraction is an expansion or contraction during a normal use time and hence, it is unnecessary to start safety measure processing such as stopping of charging or discharging. When deterioration of the battery progresses, the cell minimally or a little contracts at the time of discharging and hence, the expansion of the cell is increased.

In contrast, when an internal pressure of the cell is abnormally increased due to overcharging or the like, the cell expands rapidly. This is because a large amount of gas (oxygen) is generated due to an abnormality in chemical reaction in the cell. Usually, a pressure valve is provided to the lithium ion battery. When an internal pressure of the cell exceeds an allowable value, the pressure valve is opened so that a gas filled in the cell is released to the outside. With such a configuration, the expanded cell rapidly contracts. This expansion or contraction means that an abnormality occurs in the cell, and it is necessary to start the safety measure processing.

Management device 90 controls first electricity storage module 10 to eighth electricity storage module 80 in outer case 1a. A configuration of management device 90 may be realized by either cooperation of hardware resource and software resource or by only hardware resource. A microcomputer, a digital signal processor (DSP), a field programmable gate array (FPGA), or other large scale integrations (LSIs) can be used as the hardware resource. The software resource may be a program such as firmware.

First electricity storage module 10 to eighth electricity storage module 80 housed in the same outer case 1a exist under substantially the same environmental condition and hence, first electricity storage module 10 to eighth electricity storage module 80 go through substantially the same temperature, voltage or current histories. Accordingly, all cells in outer case 1a are supposed to exhibit substantially the same expansion amount basically at any given time. Accordingly, detection values of first strain gauge S1 to eighth strain gauge S8 are also supposed to become substantially the same value basically. On the other hand, in the case where an abnormal cell is generated in a particular electricity storage module, a detection value of the strain gauge of the electricity storage module including the abnormal cell indicates a peculiar value compared to detection values of strain gauges of remaining electricity storage modules.

FIG. 2 is a view showing one example of detection values of first strain gauge S1 to eighth strain gauge S8 in the case where an abnormality is generated in the cell included in fifth electricity storage module 50. Detection values of first strain gauge S1 to sixth strain gauge S6, and eighth strain gauge S8 are within a range of from 2.0 to 2.4 inclusive (lang=EN−US>×10⁻³). In contrast, a detection value of fifth strain gauge S5 is 0.8 (lang=EN−US>×10⁻³), and only the detection value of fifth strain gauge S5 largely differs from other detection values.

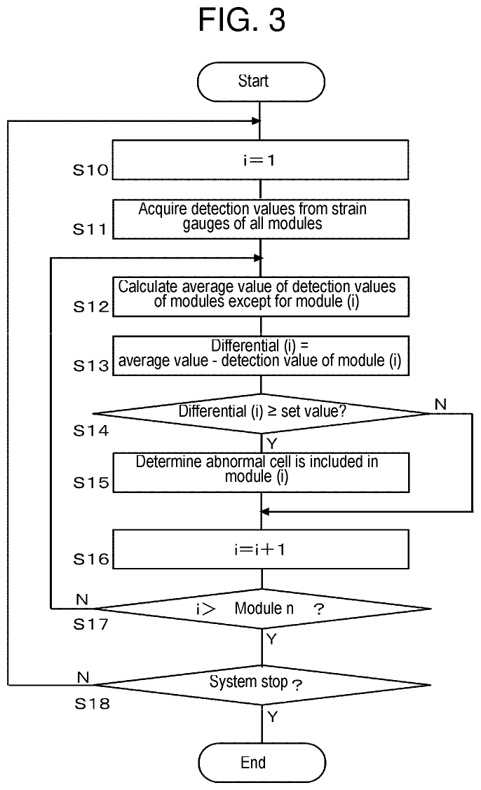

FIG. 3 is a flowchart showing a flow of a method of detecting an electricity storage module including an abnormal cell using management device 90 according to the exemplary embodiment of the present invention. Management device 90 sets 1 to a variable i as an initial value (S10). Management device 90 acquires detection values from the respective strain gauges of all the electricity storage modules (S11).

Management device 90 calculates an average value of detection values of the strain gauges of the remaining electricity storage modules except for electricity storage module (i) (S12). Management device 90 calculates a differential (i) by subtracting a detection value of the strain gauge of electricity storage module (i) from the average value (S13). Management device 90 determines whether or not differential (i) is equal to or more than a set value (S14). The set value is set to a value derived by a designer based on the specifications of the batteries, and experimental data or simulation data when an abnormal cell occurs.

When differential (i) is equal to or more than the set value (Y in S14), management device 90 determines that an abnormal cell is included in electricity storage module (i) (S15). When differential (i) is less than the set value (N in S14), processing of step S15 is skipped.

Management device 90 increments variable i (S16), and determines whether or not variable i exceeds module number n (S17). When variable i is equal to or less than module number n (N in S17), processing is shifted to step S12, and the determination processing of the presence or the non-presence of an abnormal cell in another electricity storage module is continued. When variable i exceeds module number n (Y in S17), determination processing of single unit is finished. Until electricity storage system 1 stops (Y in S18), pieces of processing in steps S10 to S17 are repeatedly performed (N in S18).

In steps S12, S13, an average value of detection values of the plurality of strain gauges is used. However, a median may be used in place of the average value. Further, in place of using the average value or the median of the detection values of the strain gauges mounted on the electricity storage modules except for electricity storage module (i), an average value or a median of the detection values of the strain gauges mounted on all of the electricity storage modules may be used.

In the case where electricity storage system 1 is a drive battery mounted on a hybrid vehicle or an electric vehicle, management device 90 notifies a host electronic control unit (ECU) of an abnormality of the drive battery via a vehicle-mounted network such as a control area network (CAN) or the like when management device 90 detects an electricity storage module including an abnormal cell. The ECU informs a driver of an abnormality of the drive battery. For example, an abnormality lamp of the drive battery mounted on an instrumental panel is lit. An abnormality of the drive battery may be notified to a driver using a voice message.

In the case where electricity storage system 1 is a drive battery mounted on a hybrid vehicle, when management device 90 detects an electricity storage module including an abnormal cell, management device 90 stops charging and discharging of the drive battery, and switches a traveling mode to engine traveling.

In the case where electricity storage system 1 is a drive battery mounted on a purely electric vehicle, both safety and convenience can be realized simultaneously by allowing self-traveling of the electric vehicle to a car dealer or a repair shop while ensuring safety. As a method of ensuring safety, cooling of electricity storage system 1 is considered. As the cooling system, there are an air-cooling system and a water-cooling system. However, hereinafter, the description is made with respect to an example where the water-cooling system having high cooling ability is used.

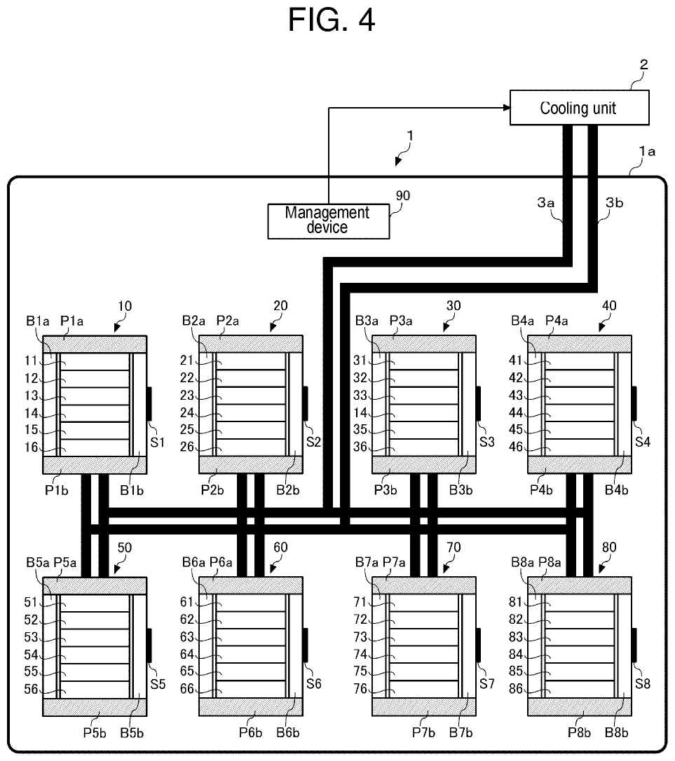

FIG. 4 is a schematic view showing a system configuration of electricity storage system 1 which is operated in cooperation with cooling unit 2. Cooling unit 2 has a heat radiator such as heat radiation fins or the like, and an electric fan for cooling a cooling liquid (hereinafter referred to as a coolant). Cooling unit 2 may be configured such that cooling unit 2 operates in an interlocking manner with an air conditioner system in a vehicle in place of the electric fan, thus cooling a coolant using cooling air from the air conditioner system.

Cooling unit 2 and electricity storage system 1 are connected to each other by filling coolant pipe 3a and discharging coolant pipe 3b. A cooling plate (not shown in the drawings) is mounted on each of first electricity storage module 10 to eighth electricity storage module 80 of electricity storage system 1. The cooling plate is mounted on the electricity storage module by way of an insulating heat conductive sheet (not shown in the drawings). In the case where the exterior can of the cell is made of an insulating material, the cooling plate may be directly mounted on the electricity storage module.

Filling coolant pipe 3a and discharging coolant pipe 3b are connected to each cooling plate. A coolant which is filled in each cooling plate through filling coolant pipe 3a circulates inside of the cooling plate, and is discharged from discharging coolant pipe 3b.

When management device 90 detects an electricity storage module including an abnormal cell, management device 90 instructs cooling unit 2 to increase cooling ability. For example, in the case where an electric fan is used, management device 90 instructs cooling unit 2 to increase a rotational speed of the electric fan for lowering a temperature of the coolant. For example, management device 90 may instruct cooling unit 2 so that the electric fan rotates at a maximum rotational speed. In the case where the coolant is cooled by an air conditioner, management device 90 instructs cooling unit 2 to lower a temperature of a cooling air or to increase an amount of cooling air. A rotational speed of the electric fan, and a temperature or an amount of air of cooling air of the air conditioner may be set according to the differential (i) shown in FIG. 3. That is, management device 90 issues an instruction such that the larger the differential (i) is, the faster a rotational speed of the electric fan becomes, the lower a temperature of cooling air of the air conditioner becomes, and the larger an amount of cooling air becomes.

It is also considered that, for maintaining a state where the electric vehicle can perform self-traveling while ensuring safety, a circuit configuration is changed to a configuration where an electricity storage module including an abnormal cell is electrically separated. In the hybrid vehicle or electric vehicle, direct-current (DC) power supplied from electricity storage system 1 is converted into alternating-current (AC) power by an inverter (not shown in the drawings), and the AC power is supplied to the drive motor.

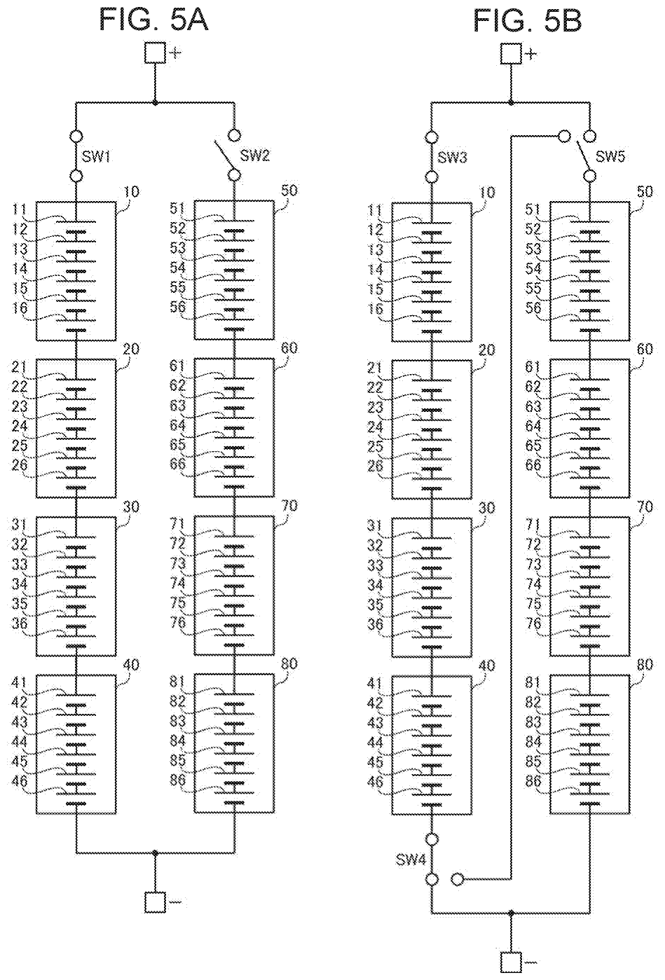

FIG. 5(a) and FIG. 5(b) are views showing a reconfiguration example of first electricity storage module 10 to eighth electricity storage module 80 at the time of detecting an electricity storage module including an abnormal cell. The examples shown in FIG. 5(a) and FIG. 5(b) are described on the premise that a circuit configuration is adopted where first electricity storage module 10 to fourth electricity storage module 40 are connected in series, fifth electricity storage module 50 to eighth electricity storage module 80 are connected in series, and these two series circuits are connected parallel to each other.

In the example shown in FIG. 5(a), first switch SW1 is disposed between a positive-electrode terminal of entire electricity storage system 1 and a positive-electrode terminal of first electricity storage module 10, and second switch SW2 is disposed between a positive-electrode terminal of entire electricity storage system 1 and a positive-electrode terminal of fifth electricity storage module 50. As first switch SW1 and second switch SW2, a mechanical relay or a semiconductor switch can be used.

In the case where an electricity storage module including an abnormal cell is not detected, management device 90 performs a control so as to bring first switch SW1 and second switch SW2 into an ON state. In the case where an electricity storage module including an abnormal cell is detected, management device 90 turns off a switch of a series circuit to which the electricity storage module including the abnormal cell belongs. In this exemplary embodiment, fifth electricity storage module 50 includes an abnormal cell and hence, second switch SW2 is turned off. In the example shown in FIG. 5(a), although an output current of electricity storage system 1 is halved, an output voltage of electricity storage system 1 can be maintained.

In an example shown in FIG. 5(b), third switch SW3 is disposed between the positive-electrode terminal of entire electricity storage system 1 and the positive-electrode terminal of first electricity storage module 10. Fourth switch SW4 is disposed between a negative-electrode terminal of fourth electricity storage module 40 and a negative-electrode terminal of entire electricity storage system 1 or a positive-electrode terminal of fifth electricity storage module 50. Fifth switch SW5 is disposed between a positive-electrode terminal of fifth electricity storage module 50 and a positive-electrode terminal of entire electricity storage system 1 or the negative-electrode terminal of fourth electricity storage module 40. Fourth switch SW4 and fifth switch SW5 are formed of a C contact point switch.

In the case where an electricity storage module including an abnormal cell is not detected, management device 90 performs a control where third switch SW3 is brought into an ON state, a connection destination of fourth switch SW4 is set to a positive-electrode terminal side of fifth electricity storage module 50, and a connection destination of fifth switch SW5 is set to a negative-electrode terminal side of fourth electricity storage module 40. In the case where an electricity storage module including an abnormal cell is detected, management device 90 electrically separates a series circuit to which an electricity storage module including an abnormal cell belongs from entire electricity storage system 1.

In this exemplary embodiment, since fifth electricity storage module 50 includes an abnormal cell, management device 90 switches a connection destination of fourth switch SW4 to a negative-electrode terminal side of entire electricity storage system 1, and electrically separates fifth switch SW5 from both of the positive-electrode terminal of entire electricity storage system 1 and the negative-electrode terminal of fourth electricity storage module 40. In the case where any one of first electricity storage module 10 to fourth electricity storage module 40 includes an abnormal cell, management device 90 brings third switch SW3 into an OFF state, separates the connection destination of fourth switch SW4 electrically from the positive-electrode terminal of fifth electricity storage module 50, and sets a connection destination of fifth switch SW5 to a positive-electrode terminal side of fifth electricity storage module 50. In an example shown in FIG. 5(b), although an output voltage of electricity storage system 1 is halved, an output current of electricity storage system 1 can be maintained.

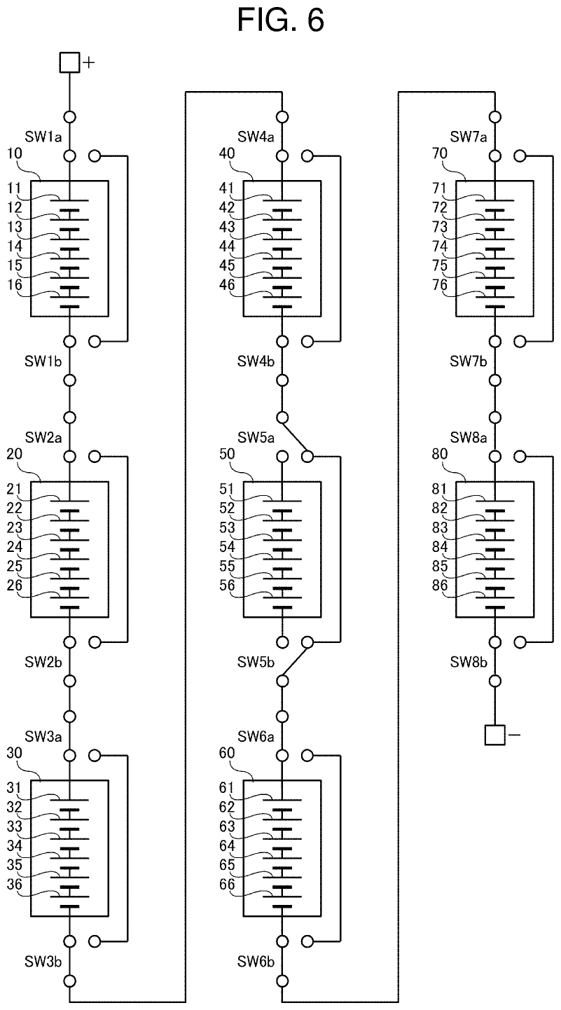

FIG. 6 is a view showing another reconfiguration example of first electricity storage module 10 to eighth electricity storage module 80 at the time of detecting an electricity storage module including an abnormal cell. An example shown in FIG. 6 is described on the premise that a circuit configuration is adopted where all of first electricity storage module 10 to eighth electricity storage module 80 are connected in series.

In the example shown in FIG. 6, a bypass switch is mounted on the positive-electrode terminals and the negative-electrode terminals of first electricity storage module 10 to eighth electricity storage module 80 respectively. In the case where an electricity storage module including an abnormal cell is detected, management device 90 switches two switches respectively connected to the positive-electrode terminal and the negative-electrode terminal of the electricity storage module including the abnormal cell to a bypass path side. In this exemplary embodiment, since fifth electricity storage module 50 includes an abnormal cell, management device 90 switches switch SW5a connected to the positive-electrode terminal of fifth electricity storage module 50 and switch SW5b connected to the negative-electrode terminal of fifth electricity storage module 50, to the bypass path side. With such an operation, the electricity storage module including the abnormal cell is electrically bypassed. In the example shown in FIG. 6, although a number of switches is increased, the lowering of an output voltage of entire electricity storage system 1 can be suppressed to an amount corresponding to the lowering of a voltage corresponding to only one electricity storage module.

As has been described above, according to the present exemplary embodiment, by comparing strain amounts of first electricity storage module 10 to eighth electricity storage module 80 housed in the same outer case 1a with each other, the presence or the non-presence of an abnormality in the cell can be detected with simple configuration and with high accuracy. The presence or the non-presence of an abnormality is determined by performing a relative comparison and hence, it is unnecessary to keep histories of detection values of first strain gauge S1 to eighth strain gauge S8. Accordingly, it is possible to omit acquisition and management of a log of the detection values. Further, it is unnecessary to compare a strain amount of each electricity storage module which is an absolute value and a threshold with each other and hence, it is unnecessary to amplify a minute detection value using an amplifier, thus capable of omitting the amplifier. Further, it is unnecessary to set a threshold to be compared with a strain amount itself which is an absolute value. Accordingly, an ex-ante evaluation for deciding thresholds becomes unnecessary. Accordingly, the development period of electricity storage system 1 can be largely shortened. Further, also in the case where electricity storage system 1 is used in an unexpected use state, electricity storage system 1 can flexibly cope with such a state thus preventing the occurrence of an erroneous detection. Strain amounts of the electricity storage modules are relatively compared with each other and hence, provided that the environmental conditions in outer case 1a are satisfied, other factors can be basically ignored.

The present invention has been described heretofore based on the exemplary embodiment. The above exemplary embodiment is intended to be illustrative only, and the person of ordinary skill in the art will understand that various modified examples are possible with respect to the combination of configuration elements and processing processes in the exemplary embodiment and that such modifications are also within the scope of the present invention.

In the above-mentioned exemplary embodiment, the description has been made by taking the case where the strain gauge is attached to the side bind bar of the electricity storage module, and the expansion or contraction of the cell is detected by detecting the expansion or contraction of the side bind bar using the strain gauge as an example. In this respect, for example, the expansion or contraction of the cell may be detected by providing a pressure sensor between the end plate of the electricity storage module and the cell which opposedly faces the end plate. Any sensor can be used which can detect physical displacement or a stress which is generated along with expansion or contraction of the cell.

In step S14 shown in FIG. 3, a plurality of set values may be set. The smallest set value is set as a value for detecting a sign that a serious abnormality occurs. In this case, a fact that there is a possibility that a serious abnormality occurs is notified to a driver as an alert. Further, the cooling ability of cooling unit 2 may be increased preliminarily. In this stage of operation, there is also a possibility that the detection is made erroneously and hence, stopping of charging or discharging and electrical separation of the electricity storage module is not performed.

In the above-mentioned exemplary embodiment, although the description has been made by taking the case where the electricity storage module is formed by stacking the plurality of rectangular cells as an example, the electricity storage module may be formed by stacking a plurality of laminate-type cells to each other.

The exemplary embodiment may be specified by items described below.

### [Item 1]

Electricity storage system (1) including: a plurality of electricity storage modules (10 to 80) each including a plurality of cells (11 to 16, 21 to 26, . . . , 81 to 86) that are bound in a state where the plurality of cells are stacked in a row; and

management device (90) that acquires detection values from sensors (S1 to S8) that are respectively mounted on the plurality of electricity storage modules (10 to 80) so as to detect expansion or contraction of the plurality of cells (11 to 16, 21 to 26, . . . , 81 to 86) in a stacking direction, wherein

management device (90) is configured to compare a detection value acquired from sensor (S1) mounted on one electricity storage module (10) to be inspected out of the plurality of electricity storage modules and detection values acquired from the sensors (S2 to S8) mounted on other electricity storage modules (20 to 80), and to detect an abnormality in at least one of cells (11 to 16) included in one electricity storage module (10) to be inspected.

management device (90) is configured to detect an abnormality in cell (11 to 16) included in electricity storage module (10) that is an object to be inspected by comparing a detection value acquired from sensor (S1) mounted on electricity storage module (10) that is the object to be inspected and detection values acquired from sensors (S2 to S8) mounted on remaining electricity storage modules (20 to 80) with each other.

With such a configuration, an abnormality in cell (11 to 16, 21 to 26, . . . , 81 to 86) can be detected with the simple configuration and with high accuracy.

### [Item 2]

Electricity storage system (1) described in Item 1, wherein management device (90) calculates a differential between the detection value acquired from sensor (S5) mounted on one electricity storage module (50) to be inspected out of the plurality of electricity storage modules and an average value or a median of detection values acquired from sensors (S1 to S4, S6 to S8) mounted on other electricity storage modules (10 to 40, 60 to 80) or from all sensors (S1 to S8) mounted on all electricity storage modules (10 to 80), and determines one electricity storage module (50) where the differential is equal to or more than a set value, as an electricity storage module including an abnormal cell.

With such a configuration, it is possible to specify an electricity storage module exhibiting a peculiar detection value.

### [Item 3]

Electricity storage system (1) described in Item 1 or 2, wherein electricity storage module (10) includes:

two end plates (P1a, P1b) that are disposed on both end surfaces of an assembly of the plurality of cells (11 to 16) in the stacking direction so as to sandwich the plurality of cells (11 to 16); and

at least two bind bars (B1a, B1b) for connecting two end plates (P1a, P1b) to each other,

sensor (S1) is a strain gauge, and

the strain gauge is attached to at least one of bind bars (B1a, B1b).

With such a configuration, the expansion or contraction of the cell can be detected from the expansion or contraction of the bind bar.

### [Item 4]

Electricity storage system (1) described in any one of Items 1 to 3, wherein the cell is a rectangular cell or a laminate-type cell.

With such a configuration, the cells can be easily stacked to each other, and the expansion or contraction of any one of the cells can be easily detected from the outside.

### [Item 5]

Electricity storage system (1) described in any one of Items 1 to 4, wherein management device (90) enhances cooling ability of cooling unit (2) when management device (90) detects electricity storage module (50) including an abnormal cell.

With such a configuration, it is possible to alleviate the expansion of an abnormal cell.

### [Item 6]

Electricity storage system (1) described in any one of Items 1 to 5, wherein management device (90) changes a circuit configuration into a configuration where electricity storage module (50) is electrically separated from remaining electricity storage modules when management device (90) detects electricity storage module (50) including an abnormal cell.

With such a configuration, stopping of charging or discharging of entire electricity storage system (1) can be avoided.

### [Item 7]

Management device (90) that controls a plurality of electricity storage modules (10 to 80) each including a plurality of cells (11 to 16, 21 to 26, . . . , 81 to 86) that are bound in a state where the plurality of cells are stacked in a row, wherein

management device 90 acquires detection values from sensors (S1 to S8) that are respectively mounted on the plurality of electricity storage modules (10 to 80) so as to detect expansion or contraction of the plurality of cells (11 to 16, 21 to 26, . . . , 81 to 86) in a stacking direction, and

management device (90) is configured to detect an abnormality in cell (11 to 16) included in electricity storage module (10) that is an object to be inspected by comparing a detection value acquired from sensor (S1) mounted on electricity storage module (10) that is the object to be inspected and detection values acquired from sensors (S2 to S8) mounted on remaining electricity storage modules (20 to 80) with each other.

With such a configuration, an abnormality in cell (11 to 16, 21 to 26, . . . , 81 to 86) can be detected with the simple configuration and with high accuracy.

### REFERENCE MARKS IN THE DRAWINGS

1: electricity storage system
1a: outer case
10 to 80: first electricity storage module to eighth electricity storage module
11 to 16, 21 to 26, 31 to 36, 41 to 46, 51 to 56, 61 to 66, 71 to 76, and 81 to 86: cell
B1a, B1b to B8a, B8b: bind bar
P1a, P1b to P8a, P8b: end plate
S1 to S8: first strain gauge to eighth strain gauge
90: management device
2: cooling unit
3a: filling coolant pipe
3b: discharging coolant pipe
SW1 to SW5: first switch to fifth switch

1. An electricity storage system comprising: a plurality of electricity storage modules each including a plurality of cells that are bound in a state where the plurality of cells are stacked in a row; and
a management device that acquires detection values from sensors that are respectively mounted on the plurality of electricity storage modules so as to detect expansion or contraction of the plurality of cells in a stacking direction, wherein
the management device is configured to compare a detection value acquired from the sensor mounted on one electricity storage module to be inspected out of the plurality of electricity storage modules and detection values acquired from the sensors mounted on other electricity storage modules, and to detect an abnormality in at least one of the cells included in the one electricity storage module to be inspected.

2. The electricity storage system according to claim 1, wherein the management device calculates a differential between the detection value acquired from the sensor mounted on the one electricity storage module to be inspected out of the plurality of electricity storage modules and an average value or a median of detection values acquired from the sensors mounted on the other electricity storage modules or from the all sensors mounted on all the electricity storage modules, and determines the one electricity storage module where the differential is equal to or more than a set value, as an electricity storage module including an abnormal cell.

3. The electricity storage system according to claim 1, wherein each of the electricity storage modules includes:
two end plates that are disposed on both end surfaces of an assembly of the plurality of cells in the stacking direction so as to sandwich the plurality of cells between the two end plates; and
at least two bind bars for connecting the two end plates to each other,
the sensor is a strain gauge, and
the strain gauge is attached to at least one of the bind bars.

4. Electricity storage system according to claim 1, wherein the cell is a rectangular cell or a laminate-type cell.

5. The electricity storage system according to claim 1, wherein the management device enhances cooling ability of a cooling unit when the management device detects an electricity storage module including an abnormal cell.

6. The electricity storage system according to claim 1, wherein the management device changes a circuit configuration into a configuration where an electricity storage module including an abnormal cell is electrically separated from remaining electricity storage modules when the management device detects the electricity storage module including the abnormal cell.

7. A management device that controls a plurality of electricity storage modules each including a plurality of cells that are bound in a state where the plurality of cells are stacked in a row, wherein
the management device acquires detection values from sensors that are respectively mounted on the plurality of electricity storage modules so as to detect expansion or contraction of the plurality of cells in a stacking direction, and
the management device is configured to compare a detection value acquired from the sensor mounted on one electricity storage module to be inspected out of the plurality of electricity storage modules and detection values acquired from the sensors mounted on other electricity storage modules, and to detect an abnormality in at least one of the cells included in the one electricity storage module to be inspected.
